(19) United States
(12) Patent Application Publication
(10) Pub. No.: US 2025/0118293 A1
(43) Pub. Date: Apr. 10, 2025

(54) CHAIN OF THOUGHT REASONING FOR ASR

(71) Applicant: Google LLC, Mountain View, CA (US)

(72) Inventors: Mingqing Chen, Saratoga, CA (US); Rajiv Mathews, Sunnyvale, CA (US); Andrew Hard, Seattle, WA (US); Swaroop Ramaswamy, Mountain View, CA (US); Kilol Gupta, Mountain View, CA (US)

(73) Assignee: Google LLC, Mountain View, CA (US)

(21) Appl. No.: 18/891,615

(22) Filed: Sep. 20, 2024

Related U.S. Application Data
(60) Provisional application No. 63/589,147, filed on Oct. 10, 2023.

(51) Int. Cl. G10L 15/06; G10L 15/26; G10L 25/30

(52) U.S. Cl. CPC G10L 15/063; G10L 15/26; G10L 25/30

(57) ABSTRACT

A method includes receiving a conversational training dataset including a plurality of conversational training samples, each training sample associated with a corresponding conversation and including: corresponding audio data characterizing a corresponding current utterance spoken by a user during a current turn in the corresponding conversation; a corresponding context for the corresponding current utterance including a transcript of a previous turn in the corresponding conversation that precedes the current turn; a corresponding ground-truth transcription of the corresponding current utterance; and a CoT annotation representing a corresponding logical relationship between the corresponding current utterance and the previous turn. The method also includes, for each corresponding conversational training sample in the conversational training dataset, training a speech model on the corresponding conversational training sample to teach the speech model to learn how to predict the corresponding logical relationship from the corresponding audio data and the corresponding context.

### CROSS-REFERENCE TO RELATED APPLICATIONS

This U.S. Patent Application claims priority under 35 U.S.C. § 119 (e) to U.S. Provisional Application 63/589,147, filed on Oct. 10, 2023. The disclosure of this prior application is considered part of the disclosure of this application and is hereby incorporated by reference in its entirety.

### TECHNICAL FIELD

This disclosure relates to chain of thought reasoning for automatic speech recognition (ASR).

### BACKGROUND

Increasingly, users are utilizing digital assistants to, for example, obtain information or perform actions. Users are increasingly utilizing spoken utterances to interact with digital assistants via conversational user interfaces. Here, a digital assistant may rely on transcriptions of spoken utterances determined using automatic speech recognition (ASR).

### SUMMARY

One aspect of the disclosure provides a computer-implemented method for training a speech model for using chain of thought (CoT) reasoning for ASR includes receiving a conversational training dataset including a plurality of conversational training samples, each conversational training sample in the conversational training dataset associated with a corresponding conversation and including: corresponding audio data characterizing a corresponding current utterance spoken by a user during a current turn in the corresponding conversation; a corresponding context for the corresponding current utterance, the corresponding context including a transcript of a previous turn in the corresponding conversation that precedes the current turn; a corresponding ground-truth transcription of the corresponding current utterance; and a chain-of-thought (CoT) annotation representing a corresponding logical relationship between the corresponding current utterance and the previous turn in the corresponding conversation; and, for each particular conversational training sample in the conversational training dataset, training a speech model on the particular conversational training sample to teach the speech model to learn how to predict the corresponding logical relationship from the corresponding audio data and the corresponding context.

Implementations of the disclosure may include one or more of the following optional features. The corresponding logical relationship represented by a corresponding CoT annotation may indicate that at least one term is contained in both the corresponding ground-truth transcription of the corresponding current utterance and the transcript of the previous turn. Additionally or alternatively, a corresponding logical relationship represented by the corresponding CoT annotation may indicate that at least one term contained in the transcript of the previous turn is topically relevant to one or more different terms contained in the corresponding ground-truth transcription of the corresponding current utterance. Additionally or alternatively, a corresponding logical relationship represented by the corresponding CoT annotation may indicate that the transcript of the previous turn does not contain any terms that are topically relevant to the corresponding ground-truth transcription of the corresponding current utterance. In some examples, a corresponding CoT annotation for at least one of the plurality of conversational training samples is manually written by a human labeler. Additionally or alternatively, a corresponding CoT annotation for at least one of the plurality of conversational training samples is generated by a knowledge graph.

In some implementations, training the speech model on the particular conversational training sample includes: processing, by the speech model, the corresponding audio data and the corresponding context to generate a predicted logical relationship between the corresponding current utterance and the previous turn in the corresponding conversation; determining a first cross-entropy loss term for the particular conversational training sample based on the predicted logical relationship and the corresponding logical relationship represented by the corresponding CoT annotation; and training the speech model on the first cross-entropy loss term determined for the particular conversational training sample. In some implementations, training the speech model on the particular conversational training sample includes training the speech model on the particular conversational training sample to teach the speech model to learn how to predict the corresponding ground-truth transcription for the corresponding current utterance by: processing, by the speech model, the corresponding audio data and the corresponding context to generate a predicted transcription for the corresponding current utterance; determining a second cross-entropy loss term for the particular conversational training sample based on the predicted transcription for the corresponding current utterance and the corresponding ground-truth transcription of the corresponding current utterance; and training the speech model on the second cross-entropy loss term determined for the particular conversational training sample.

In some implementations, the speech model is trained to generate the predicted logical relationship between the corresponding current utterance and the previous turn in the corresponding conversation as an intermediate processing step prior to generating the predicted transcription for the corresponding current utterance. In some examples, the speech model is a speech-text language model including an audio encoder and a large language model decoder. The large language model decoder may, during inference, generates a CoT annotation for using CoT reasoning during speech recognition.

Another aspect of the disclosure provides a system including data processing hardware, and memory hardware in communication with the data processing hardware and storing instructions that, when executed on the data processing hardware, causes the data processing hardware to perform operations. The operations including receiving a conversational training dataset including a plurality of conversational training samples, each conversational training sample in the conversational training dataset associated with a corresponding conversation and including: corresponding audio data characterizing a corresponding current utterance spoken by a user during a current turn in the corresponding conversation; a corresponding context for the corresponding current utterance, the corresponding context including a transcript of a previous turn in the corresponding conversation that precedes the current turn; a corresponding ground-truth transcription of the corresponding current utterance; and a chain-of-thought (CoT) annotation representing a corresponding logical relationship between the corresponding current utterance and the previous turn in the corresponding conversation; and, for each particular conversational training sample in the conversational training dataset, training a speech model on the particular conversational training sample to teach the speech model to learn how to predict the corresponding logical relationship from the corresponding audio data and the corresponding context.

Implementations of the disclosure may include one or more of the following optional features. The corresponding logical relationship represented by a corresponding CoT annotation may indicate that at least one term is contained in both the corresponding ground-truth transcription of the corresponding current utterance and the transcript of the previous turn. Additionally or alternatively, a corresponding logical relationship represented by the corresponding CoT annotation may indicate that at least one term contained in the transcript of the previous turn is topically relevant to one or more different terms contained in the corresponding ground-truth transcription of the corresponding current utterance. Additionally or alternatively, a corresponding logical relationship represented by the corresponding CoT annotation may indicate that the transcript of the previous turn does not contain any terms that are topically relevant to the corresponding ground-truth transcription of the corresponding current utterance. In some examples, a corresponding CoT annotation for at least one of the plurality of conversational training samples is manually written by a human labeler. Additionally or alternatively, a corresponding CoT annotation for at least one of the plurality of conversational training samples is generated by a knowledge graph.

In some implementations, training the speech model on the particular conversational training sample includes: processing, by the speech model, the corresponding audio data and the corresponding context to generate a predicted logical relationship between the corresponding current utterance and the previous turn in the corresponding conversation; determining a first cross-entropy loss term for the particular conversational training sample based on the predicted logical relationship and the corresponding logical relationship represented by the corresponding CoT annotation; and training the speech model on the first cross-entropy loss term determined for the particular conversational training sample. In some implementations, training the speech model on the particular conversational training sample includes training the speech model on the particular conversational training sample to teach the speech model to learn how to predict the corresponding ground-truth transcription for the corresponding current utterance by: processing, by the speech model, the corresponding audio data and the corresponding context to generate a predicted transcription for the corresponding current utterance; determining a second cross-entropy loss term for the particular conversational training sample based on the predicted transcription for the corresponding current utterance and the corresponding ground-truth transcription of the corresponding current utterance; and training the speech model on the second cross-entropy loss term determined for the particular conversational training sample.

In some implementations, the speech model is trained to generate the predicted logical relationship between the corresponding current utterance and the previous turn in the corresponding conversation as an intermediate processing step prior to generating the predicted transcription for the corresponding current utterance. In some examples, the speech model is a speech-text language model including an audio encoder and a large language model decoder. The large language model decoder may, during inference, generates a CoT annotation for using CoT reasoning during speech recognition.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system using a speech model that uses chain of thought (CoT) reasoning for automated speech recognition (ASR).

FIG. 2 is a flowchart of an example arrangement of operations for a computer-implemented method of using CoT reasoning for ASR.

FIG. 3 is a schematic view of an example training process for training a speech model for using CoT reasoning for ASR.

FIG. 4 is a flowchart of another example arrangement of operations for a computer-implemented method of training a speech model for using CoT reasoning for ASR.

FIG. 5 is a schematic view of an example computing device that may be used to implement the systems and methods described herein.

Like reference symbols in the various drawings indicate like elements.

### DETAILED DESCRIPTION

Increasingly, users are utilizing digital assistants to, for example, obtain information or perform actions. Users are increasingly utilizing spoken utterances to interact with digital assistants via conversational user interfaces. Here, a digital assistant may rely on transcriptions of the spoken utterances determined using automatic speech recognition (ASR). Chain of thought (CoT) reasoning includes the determination and use of a sequence of intermediate reasoning steps, and has been found to significantly improve the ability of large language models (LMMs) to perform complex reasoning. Because of the increasing use of, and reliance on, ASR for interacting with digital assistants via conversational user interfaces, there is a need for improving the accuracy of the speech models used for performing ASR. Systems and methods disclosed herein improve the accuracy of speech models by using CoT reasoning for ASR.

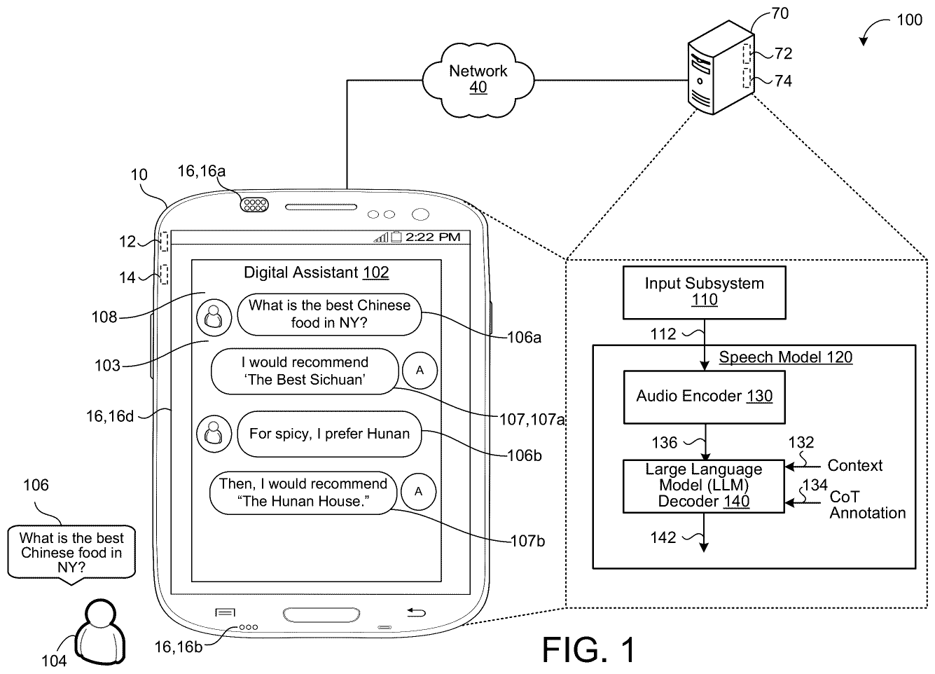

FIG. 1 is a schematic view of an example of a system 100 executing a digital assistant 102 for interacting with a user 104. In the example shown, the digital assistant 102 provides and presents a conversational user interface 103 on a display 16c of a user device 10 associated with the user 104. The conversational user interface 103 enables the digital assistant 102 and the user 104 to interact in a conversational, back-and-forth, or turn taking manner. In particular, during a conversation 108 between the user 104 and the digital assistant 102, the user speaks an utterance 106 representing a query or command that a speech model 120 transcribes into a transcription 142 of the utterance 106a. The transcription 142 is then processed by the digital assistant 102 to interpret the query and then generate a response 107 to the utterance 106. In some implementations, the digital assistant 102 includes a natural language processing/understanding (NLP/NLU) module executing on the user device 10 or a remote computing system 70, to understand and execute a user command/query specified by the utterance 106.

In the example shown, a first utterance 106a spoken by the user 104 includes the query “What is the best Chinese food in NY?” directed toward the digital assistant 102 and the digital assistant 102 returns a first response 107a “I would recommend ‘The Best Sichuan.’” In the illustrated example, after receiving the response 107a from the digital assistant 102, the user 104 speaks another utterance 106b of “For spicy, I prefer Hunan,” and the digital assistant 102 responds with a response 107b of “Then, I would recommend ‘The Hunan House.’” While in FIG. 1 the responses 107 are shown as text, they may additionally or alternatively be audibly output by the user device 10 as synthetic speech generated from the text by a text-to-speech (TTS) system (not shown). Here, the utterances 106 and the responses 107 form the conversation 108 between the user 104 and the digital assistant 102, the utterance 106b was spoken during a current turn in the conversation 108, and the utterance 106a was spoken during a previous turn in the conversation 108 that precedes the current turn. A conversation 108 may include multiple utterances spoken sequentially by a single user 104 such as when dictating something, making a presentation, etc. A conversation 108 may also be between two or more users 104, such as during a video conference.

The user device 10 may correspond to any computing device associated with a user 104 and capable of capturing audio, and providing textual or audible outputs. Some examples of user devices 10 include, but are not limited to, mobile devices (e.g., mobile phones, tablets, laptops, etc.), computers, wearable devices (e.g., a smart watch, smart glasses, smart goggles, an AR headset, a VR headset, etc.), smart appliances, Internet of things (IoT) devices, vehicle infotainment systems, smart displays, smart speakers, etc. The user device 10 includes data processing hardware 12 and memory hardware 14 in communication with the data processing hardware 12 and stores instructions, that when executed by the data processing hardware 12, cause the data processing hardware 12 to perform one or more operations. The user device 10 further includes one or more input/output devices 16, such as an audio capture device 16, 16a (e.g., a microphone) for capturing and converting spoken utterances 106 into electrical signals, an audio output device 16, 16b (e.g., a speaker) for communicating an audible audio signal (e.g., as output audio data from the user device 10), and the display 16, 16c for displaying the visual content. Of course, any number and/or type(s) of other input/output devices 16 may be used. The input/output devices 16 may reside on or be in communication with the user device 10.

A speech model 120 executes on the user device 10 of the user 104 and/or on the remote computing system 70 (e.g., one or more remote servers of a distributed system executing in a cloud-computing environment) in communication with the user device 10 via a network 40. The user device 10 and/or the remote computing system 70 also includes an input subsystem 110 configured to receive the utterances 106 spoken by the user 104 and captured by the audio capture device 16a in streaming audio, and convert the streaming audio characterizing each utterance 106 into a corresponding digital format associated with input acoustic frames 112 (also generally referred to as audio data 112) capable of being processed by the speech model 120. In the example shown, the user 104 speaks a respective utterance 106 and the input subsystem 110 converts the utterance 106 into corresponding audio data 112 for input to the speech model 120. Thereafter, the speech model 120 receives, as input, the audio data 112 corresponding to a current utterance 106, and generates/predicts, as output, a corresponding transcription 142 (e.g., recognition result/hypothesis) of the utterance 106.

The remote computing system 70 includes data processing hardware 72, and memory hardware 74 in communication with the data processing hardware 72. The memory hardware 74 stores instructions that, when executed by the data processing hardware 72, cause the data processing hardware 72 to perform one or more operations, such as those disclosed herein.

In the example shown, the speech model 120 includes a speech-text language model including an audio encoder 130 and a large language model (LLM) decoder 140. The audio encoder 130 encodes the audio data 112 characterizing the current utterance 106 spoken by the user 104 into hidden representations (i.e., audio encodings) 136. The LLM decoder 140 processes the hidden representations 136 and a context 132 that includes a transcript of a previous turn in the conversation 108 that precedes the current utterance to generate a CoT annotation 134. Notably, the context 132 may correspond to transcripts of more than one previous turns in the conversation 108. The CoT annotation 134 represents a corresponding logical relationship between the current utterance 106 and the one or more previous turns in the conversation 108. The speech model 120 may use the CoT annotation 134 for improving speech recognition accuracy when generating the transcription 142 of the current utterance 106. As such, when performing speech recognition on audio data 112 characterizing a current utterance 106, the speech model 120 may leverage the LLM decoder 140 to determine the CoT annotation 134 as an intermediary step and thereafter use the CoT annotation 134 for improving the accuracy of a final transcription 142 recognized by the speech model 120 for the current utterance 106. Here, the context 132 corresponding to the transcript of the previous turn in the conversation 108 may include a transcript of a response 107 from the digital assistant 102 during a previous turn that precedes the current utterance 106 and/or may include the transcription 142 output by the speech model 120 for a previous utterance 106 spoken by the user 104 (or another user) during the conversation 108 that precedes the current utterance 106. Example logical relationships include, but are not limited to, at least one term contained in a current utterance that is also contained in the transcript of a previous turn, no term in the transcript 142 of a previous turn is contained in the current utterance, at least one term contained in the transcript 142 of a previous turn is topically relevant to the current utterance, and no term in the transcript 142 of previous turn is topically relevant to the current utterance. Here, a term may be, for example, any word, number, name, date, time, etc.

In the example conversation 108 of FIG. 1, when the speech model 120 performs speech recognition on the audio data 112 characterizing the current utterance 106b “For spicy, I prefer Hunan”, the speech model 120 may generate a list of candidate transcriptions for the current utterance 106b where one of the candidate transcriptions includes “For spicy, I prefer Hunan”, another one of the candidate transcriptions includes “For spicy, I prefer human”, and another one of the candidate transcriptions includes “For spicy, I prefer who nan”. Notably, the terms ‘Hunan’, ‘human’, and ‘who nan’ include similar pronunciations. In some examples, the list of candidate transcriptions includes an N-best list of candidate transcriptions. Continuing with the example, the LLM decoder 140 may receive the context 132 that includes transcripts of previous turns in the conversation 108 that precede the current utterance 106b such as the transcription 142 of the previous utterance 106a spoken by the user 104 and the transcript of the response 107a output by the digital assistant 102, thereby indicating the user 104 is interested Chinese food. Here, the LLM decoder 140 may generate a respective CoT annotation 134 representing a logical relationship between the candidate transcription “For spicy, I prefer Hunan” for the current utterance 106b and the aforementioned transcripts of the previous turns that include the terms “Chinese food” and “Sichuan” that indicates the user 104 is interested in Chinese food. Here, the term “Hunan” contained in the candidate transcription and the term “Sichuan” contained in the transcript of the previous response 107a are topically relevant as types of Chinese cuisine, which is topically relevant to the term “Chinese food” contained in the transcription 142 of the previous utterance 106a spoken by the user 104 at the initial turn in the conversation 108. The LLM decoder 140 may be trained to use the context 132 as a prompt to cause the LLM decoder 140 to generate the CoT annotation 134. For instance, the CoT annotation 134 may include output text: “The terms ‘Chinese food’ and ‘Best Sichuan’ in the previous turns are helpful, as they are both related to the word ‘Hunan’ in the current turn”.

Accordingly, the LLM decoder 140 may use the CoT annotation 134 to ultimately select the candidate transcription “For spicy, I prefer Hunan” as the final transcription 142 rather than incorrectly selecting one of the other candidate transcriptions that include the terms “human” and “who nan”. In this scenario, the speech model 120 may use the CoT annotation 134 generated by the LLM decoder 140 to boost or bias speech recognition toward specific terms in candidate transcriptions or the LLM decoder 140 may operate in a second pass rescoring mode by using the CoT annotation 134 to rescore and re-rank the N-best list of candidate transcriptions generated by the speech model 120 during a first pass. Notably, the LLM decoder 140 may generate multiple CoT annotations 134 during a current turn where each CoT annotation 134 represents the logical relationship between the context 132 and a different respective one of multiple candidate transcriptions output by the speech model 120 during the current turn.

In another example conversation 108 where the user speaks an initial utterance of “what kinds of vaccines are available” followed by a response of “Pfizer and Moderna” from the digital assistant, the speech model 120 may generate a CoT annotation 134 for improving speech recognition of a next utterance spoken by the user that states “I would like Moderna”. In this example, the speech model 120 may produce initial candidate transcriptions of “I would like Modelo” and “I would like Moderna” and the context 132 fed as the prompt to the LLM decoder 140 would include the transcripts of the initial utterance and digital assistant response which includes the terms “vaccines” and “Moderna”, thereby causing the LLM decoder 140 to generate the CoT annotation 134 that indicates the current utterance likely includes the term “Moderna” since the previous assistant response included the same term “Moderna” which is topically relevant to the term “vaccines” contained in the initial utterance. The speech model 120 may use the CoT annotation 134 to correctly select “I would like Moderna” as the final transcription 142.

Another example conversation includes an initial utterance 106 of “okay, when you find something I would like to make a reservation for 2 people for Sunday at 1:28 am,” a response 107 of “I'm sorry, but I wasn't able to book a restaurant at that time, would you like to try another time?,” and another utterance 106 of “How about 12:28 pm.” Here, the context 132 would be the prior transcripts of the initial utterance and the response which both include mentions of time, and the CoT annotation 134 would represent that a candidate transcription for the current utterance 106 of “How about 12:28” which includes a time of day is topically relevant to the prior transcripts. This CoT information may, thus, cause the speech model 120 to correctly transcribe “12:28 pm” as a time of day for a reservation.

In some implementations, the speech model 120 also uses CoT reasoning for intra-utterance CoT. For example, a user may speak “I'd like a taxi to take me to the Cineworld cinema from the Gonville hotel. Here, the context 132 may include a transcription of an initial portion of the utterance which includes the term “taxi,” which can be fed to the LLM decoder 140 as a prompt to generate a CoT annotation 134 that indicates the term “Gonville hotel” contained in a candidate transcription of a final portion of the utterance is topically relevant to the word “taxi” to cause the speech model 120 to correctly recognize “Gonville” as the name of a hotel rather than some other word.

In some implementations, the audio encoder 130 includes multiple multi-head attention layers such as a conformer encoder that includes a convolutional sampling layer followed by a series of conformer blocks, which each include a feed-forward layer, a self-attention layer, a convolution layer, and another feed-forward layer. In other implementations, the multi-head attention layers of the audio encoder 130 include transformer layers or some other type of multi-head attention layers. The audio encoder 130 may include a cascaded encoder having a causal encoder for streaming speech recognition followed by a non-causal encoder stacked on the causal encoder for non-streaming speech recognition. While the example of FIG. 1 depicts an example architecture of the speech model 120 including the LLM decoder 140 performing multiple tasks of speech recognition decoding and generating CoT annotations from context 132 fed as prompts to the LLM decoder 140, the speech model 120 may include other architectures without departing from the scope of the present disclosure. For instance, the speech model 120 may include a distinct speech decoder tasked with decoding the audio encodings 136 output from the audio encoder into a lattice of one or more candidate speech recognition results, followed by the LLM decoder 140 that may be fed the context 132 including prior transcripts of previous turns and candidate speech recognition results output by the speech decoder for a current turn as a prompt to generate a CoT annotation 134. Here, the distinct speech decoder could include a recurrent neural network-transducer (RNN-T) decoder architecture that includes a prediction network, a joint network, and a Softmax layer. The LLM decoder 140 may use the CoT annotation to rescore and re-rank the candidate speech recognition results output from the distinct speech decoder to ultimately select the final transcription.

Alternatively, the audio encoder 130 converts the raw audio data 112, context 132, and CoT annotation 134 into tokens 136 by extracting embeddings from an existing speech representation model (e.g., the w2v-BERT model) and subsequently discretizing those embeddings into a limited set of tokens 136. Alternatively, the audio encoder 130 includes a universal speech model (USM) encoder. Alternatively, the audio encoder 130 includes a quantizer that is trained with an auxiliary ASR loss.

In some implementations, the LLM decoder 140 includes a transformer decoder that processes the tokens 136 to predict, at each time step, a next output token/word of a transcription 142. Here, a first layer of the transformer decoder following input preprocessing includes a token embeddings matrix that maps the integer-valued tokens 136 to dense embeddings, and a final Softmax layer that computes logits over all tokens at each position of the transcription 142. Here, the LLM decoder 140 may compute a probability distribution over possible output tokens/words 142. The LLM decoder 140 may include a unified language model (ULM) or a pathways language model (PaLM). The LLM decoder 140 may include other types of LLMs.

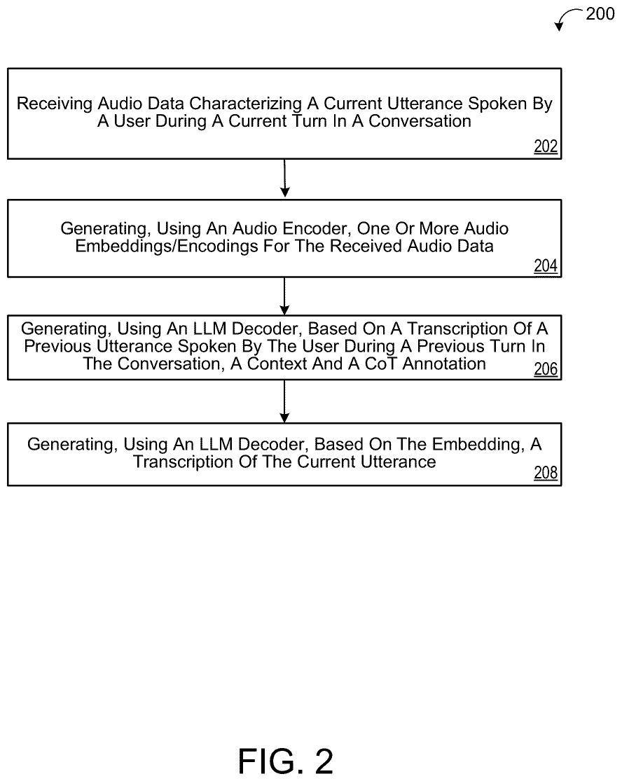

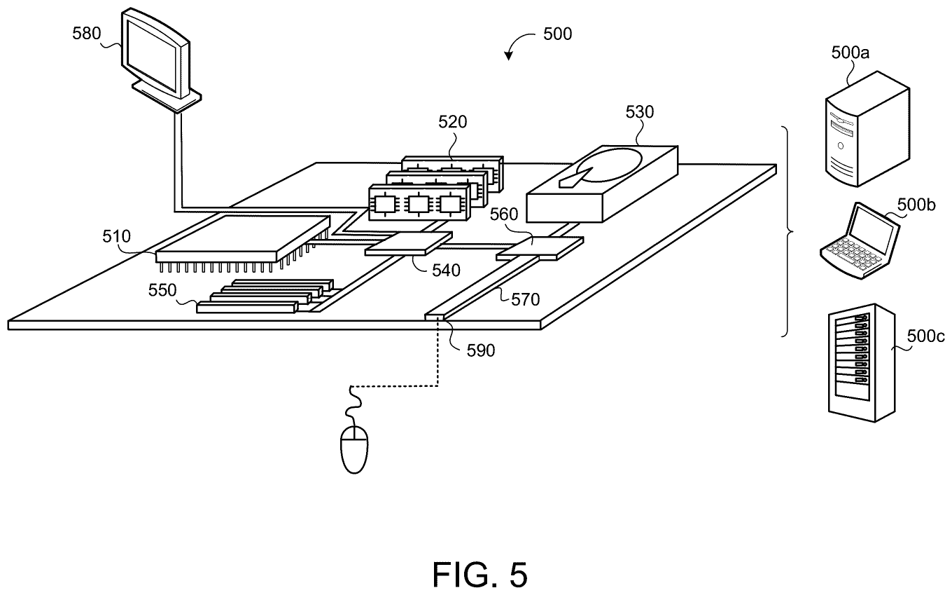

FIG. 2 is a flowchart of an exemplary arrangement of operations for a computer-implemented method 200 of using CoT reasoning during inference for ASR. The operations may be performed by data processing hardware 510 (FIG. 5) (e.g., the data processing hardware 12 of the user device 10 or the data processing hardware 72 of the remote computing system 70) based on executing instructions stored on memory hardware 520 (e.g., the memory hardware 14 of the user device 10 or the memory hardware 74 of the remote computing system 70).

At operation 202, the method 200 includes receiving audio data 112 characterizing a current utterance 106 spoken by a user 104 during a current turn in a conversation 108. At operation 204, the method 200 includes generating, using the audio encoder 130, one or more audio embeddings/encodings 136 for the received audio data 112. At operation 204, the method 200 includes generating, using the LLM decoder 140, based on a context 132 that includes a transcript of one or more previous turns in the conversation 108, and a CoT annotation 134. The CoT annotation 134 represents a logical relationship between the corresponding current utterance and the one or more previous turns in the corresponding conversation 108. That is, the LLM decoder 140 may receive, or retain internally, one or more candidate transcriptions for the current utterance 106 based speech recognition performed on the received audio data 112 by the speech model 120. Together with the context 132 including the transcript of the one or more previous turns in the conversation 108, the one or more candidate transcriptions for the current utterance 106 may prompt the LLM decoder 140 to generate the CoT annotation 134.

At operation 208, the method 200 includes generating, using the LLM decoder 140, based on the CoT annotation 134, a transcription 142 of the current utterance 106. Here, the LLM decoder 140 may use the CoT annotation 134 to rescore and rerank the one or more candidate transcriptions and ultimately select the highest scoring candidate transcription as the final transcription 142 of the current utterance 106.

In some implementations, the speech model 120 is pre-trained and is updated, during training, using a supervised-fine tuning/training with few-shot CoT prompt training process. Here, the pre-trained speech model 120 is sequentially prompted with and processes few CoT prompts (e.g., two or three). Here, each CoT prompt includes:
{a context 132},
{audio data 112 representing a current utterance 106},
{a ground-truth CoT annotation 134}, and
{a ground-truth transcription for the utterance}.

Then, during inference, a context 132 representing the transcript of a previous turn and audio data 112 for a current utterance 106 are input to the speech model 120, and the speech model 120 generates the CoT annotation 134 and the transcription 142 for the current utterance using CoT reasoning.

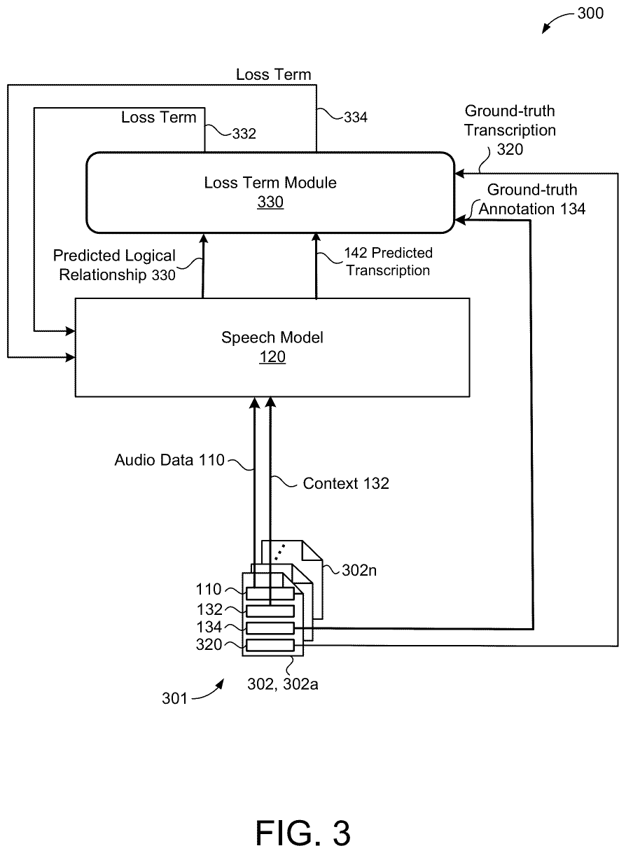

FIG. 3 is a schematic view of an example training process 300 for training the speech model 120 to use CoT reasoning for ASR. In some examples, the training process 300 fine-tunes a previously trained speech model 120 to use CoT reasoning for ASR. The training process 300 may execute on the remote system 70 (i.e., on the data processing hardware 72) or on the user device 10 (i.e., on the data processing hardware 12). The training process 300 trains the speech model 120 using a conversational training dataset 301 that includes a plurality of conversational training samples 302, 302a-n. Here, each conversational training sample 302 includes: corresponding audio data 112 characterizing a corresponding current utterance 106 spoken by a user 104 during a current turn in a corresponding conversation 108; a corresponding context 132 for the corresponding current utterance 106, the corresponding context 132 including a transcript 142 of a previous turn in the corresponding conversation 108 that precedes the current turn; a corresponding ground-truth transcription 320 of the corresponding current utterance 106; and a chain-of-thought (CoT) annotation 134 representing a corresponding logical relationship between the corresponding current utterance 106 and the previous turn in the corresponding conversation. In some examples, at least one of the CoT annotations 134 is manually written by a human labeler. Additionally or alternatively, at least one of the CoT annotations 134 is generated by a knowledge graph.

For each particular conversational training sample 302 in the conversational training dataset 301, the training process 300 trains the speech model 120 on the particular conversational training sample 302 to teach the speech model 120 to learn how to predict the corresponding logical relationship from the corresponding audio data 112 and the corresponding context 132. In particular, for each particular conversational training sample 302, the training process 300 trains the speech model 120 by processing, using the speech model 120, the corresponding audio data 112 and the corresponding context 132 to generate a predicted logical relationship 330 between the corresponding current utterance 106 and the previous turn in the corresponding conversation 108; determining a first cross-entropy loss term 332 for the particular conversational training sample 302 based on the predicted logical relationship 330 and the corresponding logical relationship represented by the corresponding CoT annotation 134; and training the speech model 120 on the first cross-entropy loss term 332 determined for the particular conversational training sample 302. Additionally, for each particular conversational training sample 302, the training process 300 trains the speech model 120 by processing, using the speech model 120, the corresponding audio data 112 and the corresponding context 132 to generate a predicted transcription 142 for the corresponding current utterance 106; determining a second cross-entropy loss term 334 for the particular conversational training sample 302 based on the predicted transcription 142 for the corresponding current utterance 106 and the ground-truth transcription 320 of the corresponding current utterance 106; and training the speech model 120 on the second cross-entropy loss term 334 determined for the particular conversational training sample 302. Here, the speech model 120 is trained to generate the predicted logical relationship 330 between the corresponding current utterance 106 and the previous turn in the corresponding conversation 108 as an intermediate processing step prior to generating the predicted transcription 142 for the corresponding current utterance 108.

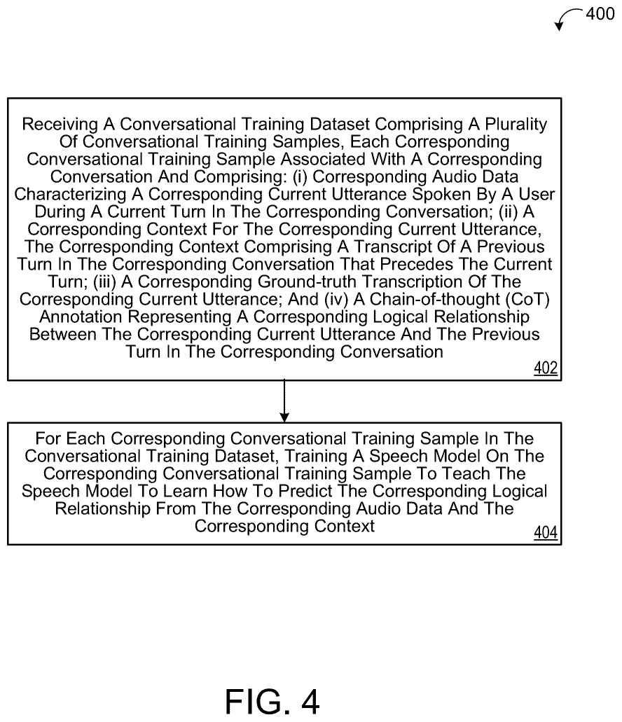

FIG. 4 is a flowchart of an exemplary arrangement of operations for a computer-implemented method 400 of training the speech model 120 to use CoT reasoning for ASR. The operations may be performed by data processing hardware 510 (FIG. 5) (e.g., the data processing hardware 12 of the user device 10 or the data processing hardware 72 of the remote computing system 70) based on executing instructions stored on memory hardware 520 (e.g., the memory hardware 14 of the user device 10 or the memory hardware 74 of the remote computing system 70).

At operation 402, the method 400 includes receiving a conversational training dataset 301 including a plurality of conversational training samples 302, each conversational training sample 302 associated with a corresponding conversation 108 and including: corresponding audio data 112 characterizing a corresponding current utterance 106 spoken by a user 104 during a current turn in the corresponding conversation 108; a corresponding context 132 for the corresponding current utterance 106, the corresponding context 132 including a transcript 142 of a previous turn in the corresponding conversation 108 that precedes the current turn; a corresponding ground-truth transcription 320 of the corresponding current utterance 106; and a chain-of-thought (CoT) annotation 134 representing a corresponding logical relationship between the corresponding current utterance 106 and the previous turn in the corresponding conversation 108.

At operation 404, the method 400 includes, for each particular conversational training sample 302 in the conversational training dataset 301, training the speech model 120 on the corresponding conversational training sample 302 to teach the speech model 120 to learn how to predict the corresponding logical relationship from the corresponding audio data 112 and the corresponding context 132.

FIG. 5 is schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510 (i.e., data processing hardware) that can be used to implement the data processing hardware 12 and/or 72, memory 520 (i.e., memory hardware) that can be used to implement the memory hardware 14 and/or 74, a storage device 530 (i.e., memory hardware) that can be used to implement the memory hardware 14 and/or 74, a high-speed interface/controller 540 connecting to the memory 520 and high-speed expansion ports 550, and a low speed interface/controller 560 connecting to a low speed bus 570 and a storage device 530 that can be used to store a conversational training dataset. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving a conversational training dataset comprising a plurality of conversational training samples, each conversational training sample in the conversational training dataset associated with a corresponding conversation and comprising:
corresponding audio data characterizing a corresponding current utterance spoken by a user during a current turn in the corresponding conversation;
a corresponding context for the corresponding current utterance, the corresponding context comprising a transcript of a previous turn in the corresponding conversation that precedes the current turn;
a corresponding ground-truth transcription of the corresponding current utterance; and
a chain-of-thought (CoT) annotation representing a corresponding logical relationship between the corresponding current utterance and the previous turn in the corresponding conversation; and
for each particular conversational training sample in the conversational training dataset, training a speech model on the particular conversational training sample to teach the speech model to learn how to predict the corresponding logical relationship from the corresponding audio data and the corresponding context.

2. The computer-implemented method of claim 1, wherein the corresponding logical relationship represented by the corresponding CoT annotation indicates that at least one term is contained in both the corresponding ground-truth transcription of the corresponding current utterance and the transcript of the previous turn.

3. The computer-implemented method of claim 1, wherein the corresponding logical relationship represented by the corresponding CoT annotation indicates that at least one term contained in the transcript of the previous turn is topically relevant to one or more different terms contained in the corresponding ground-truth transcription of the corresponding current utterance.

4. The computer-implemented method of claim 1, wherein the corresponding logical relationship represented by the corresponding CoT annotation indicates that the transcript of the previous turn does not contain any terms that are topically relevant to the corresponding ground-truth transcription of the corresponding current utterance.

5. The computer-implemented method of claim 1, wherein training the speech model on the particular conversational training sample comprises:
processing, by the speech model, the corresponding audio data and the corresponding context to generate a predicted logical relationship between the corresponding current utterance and the previous turn in the corresponding conversation;
determining a first cross-entropy loss term for the particular conversational training sample based on the predicted logical relationship and the corresponding logical relationship represented by the corresponding CoT annotation; and
training the speech model on the first cross-entropy loss term determined for the particular conversational training sample.

6. The computer-implemented method of claim 5, wherein training the speech model on the particular conversational training sample comprises training the speech model on the particular conversational training sample to teach the speech model to learn how to predict the corresponding ground-truth transcription for the corresponding current utterance by:
processing, by the speech model, the corresponding audio data and the corresponding context to generate a predicted transcription for the corresponding current utterance;
determining a second cross-entropy loss term for the particular conversational training sample based on the predicted transcription for the corresponding current utterance and the corresponding ground-truth transcription of the corresponding current utterance; and
training the speech model on the second cross-entropy loss term determined for the particular conversational training sample.

7. The computer-implemented method of claim 6, wherein the speech model is trained to generate the predicted logical relationship between the corresponding current utterance and the previous turn in the corresponding conversation as an intermediate processing step prior to generating the predicted transcription for the corresponding current utterance.

8. The computer-implemented method of claim 1, wherein the speech model comprises a speech-text language model comprising:
an audio encoder; and
a large language model decoder.

9. The computer-implemented method of claim 8, wherein the large language model decoder, during inference, generates a CoT annotation for using CoT reasoning during speech recognition.

10. The computer-implemented method of claim 1, wherein the corresponding CoT annotation for at least one of the plurality of conversational training samples is manually written by a human labeler.

11. The computer-implemented method of claim 1, wherein the corresponding CoT annotation for at least one of the plurality of conversational training samples is generated by a knowledge graph.

12. A system comprising:
data processing hardware; and
memory hardware in communication with the data processing hardware, the memory hardware storing instructions that when executed on the data processing hardware cause the data processing hardware to perform operations comprising:
receiving a conversational training dataset comprising a plurality of conversational training samples, each conversational training sample in the conversational training dataset associated with a corresponding conversation and comprising:
corresponding audio data characterizing a corresponding current utterance spoken by a user during a current turn in the corresponding conversation;
a corresponding context for the corresponding current utterance, the corresponding context comprising a transcript of a previous turn in the corresponding conversation that precedes the current turn;
a corresponding ground-truth transcription of the corresponding current utterance; and
a chain-of-thought (CoT) annotation representing a corresponding logical relationship between the corresponding current utterance and the previous turn in the corresponding conversation; and
for each particular conversational training sample in the conversational training dataset, training a speech model on the particular conversational training sample to teach the speech model to learn how to predict the corresponding logical relationship from the corresponding audio data and the corresponding context.

13. The system of claim 12, wherein the corresponding logical relationship represented by the corresponding CoT annotation indicates that at least one term is contained in both the corresponding ground-truth transcription of the corresponding current utterance and the transcript of the previous turn.

14. The system of claim 12, wherein the corresponding logical relationship represented by the corresponding CoT annotation indicates that at least one term contained in the transcript of the previous turn is topically relevant to one or more different terms contained in the corresponding ground-truth transcription of the corresponding current utterance.

15. The system of claim 12, wherein the corresponding logical relationship represented by the corresponding CoT annotation indicates that the transcript of the previous turn does not contain any terms that are topically relevant to the corresponding ground-truth transcription of the corresponding current utterance.

16. The system of claim 12, wherein training the speech model on the particular conversational training sample comprises:
processing, by the speech model, the corresponding audio data and the corresponding context to generate a predicted logical relationship between the corresponding current utterance and the previous turn in the corresponding conversation;
determining a first cross-entropy loss term for the particular conversational training sample based on the predicted logical relationship and the corresponding logical relationship represented by the corresponding CoT annotation; and
training the speech model on the first cross-entropy loss term determined for the particular conversational training sample.

17. The system of claim 16, wherein training the speech model on the particular conversational training sample comprises training the speech model on the particular conversational training sample to teach the speech model to learn how to predict the corresponding ground-truth transcription for the corresponding current utterance by:
processing, by the speech model, the corresponding audio data and the corresponding context to generate a predicted transcription for the corresponding current utterance;
determining a second cross-entropy loss term for the particular conversational training sample based on the predicted transcription for the corresponding current utterance and the corresponding ground-truth transcription of the corresponding current utterance; and
training the speech model on the second cross-entropy loss term determined for the particular conversational training sample.

18. The system of claim 17, wherein the speech model is trained to generate the predicted logical relationship between the corresponding current utterance and the previous turn in the corresponding conversation as an intermediate processing step prior to generating the predicted transcription for the corresponding current utterance.

19. The system of claim 12, wherein the speech model comprises a speech-text language model comprising:
an audio encoder; and
a large language model decoder.

20. The system of claim 19, wherein the large language model decoder, during inference, generates a CoT annotation for using CoT reasoning during speech recognition.

21. The system of claim 12, wherein the corresponding CoT annotation for at least one of the plurality of conversational training samples is manually written by a human labeler.

22. The system of claim 12, wherein the corresponding CoT annotation for at least one of the plurality of conversational training samples is generated by a knowledge graph.
